(19) United States
(12) Patent Application Publication
(10) Pub. No.: US 2006/0139335 A1
(43) Pub. Date: Jun. 29, 2006

(54) Assembly and device for a display having a perimeter touch guard seal

(75) Inventors: David Campbell Brower, Wake Forest, NC (US); Robert Scott Fortenberry, Raleigh, NC (US); Richard Hunter Harris, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/020,726

(22) Filed: Dec. 23, 2004

(51) Int. Cl. G09G 5/00

(52) U.S. Cl. 345/173

(57) ABSTRACT

An assembly and device that provides a flexible, removable and sealable touch guard system for use with retail display systems and more specifically for use with displays requiring repeated human interactive use is provided for. More particularly, the present invention relates to an assembly and device that provides a sealable touch guard between a bezel, a protective covering and a display while under compression. Additionally the present invention is readily used with customer-specific bezel covers and displays often used with point of sale (POS)-like terminals.

### BACKGROUND OF THE INVENTION

1. The Field of the Invention

The present invention relates in general to an assembly and device that provides a flexible, removable and sealable touch guard system for use with retail display systems and more specifically for use with displays requiring repeated human interactive use. More particularly, the present invention relates to an assembly and device that provides a sealable touch guard with customer-specific bezel covers for displays often used with point of sale (POS)-like terminals.

2. Description of the Related Art

It is widely known that computer systems are used and integrated with most retail related environments. Examples of this include the use of Point of Sale (POS) devices, cash registry and inventory control devices, and various computerized systems in retail environments such as groceries, superstores and department stores. Now, it is becoming more commonplace for consumers to be offered the opportunity to use a self-checkout (SCO) system, which typically comprises many of the characteristics of a POS and a checkout lane with the added benefit of allowing the consumer to conduct the checkout process. Similarly, POS-types of systems are also used at automated teller machine (ATM) locations, fast food locations and kiosks throughout the retail and banking sectors. Other variations of these types of system include those that can use a display technology in combination with smart cards, credit cards or biometric identifiers. These types of systems are referred to hereinafter as POS systems, touch sensitive devices, assemblies an devices, though such descriptions are intended to be inclusive and instructive to any and all computer systems having a display that is touch-sensitive and/or is used to accommodate the interactive input of instructions from users by hand, finger, eye (or similar biometric basis), pen, stylus or pointing stick.

FIG. 1 is a depiction of a common touch screen type of device, such as a point of sale terminal. As shown in FIG. 1, one common type of interactive computer system 10 permits an operator to enter information into the computer traditionally via keypad 18 or selectively via touching points on the screen 15 of a computer monitor or display device, such as a Cathode Ray Tube (CRT) or Liquid Crystal Display LCD), upon which is displayed relevant information.

One such touch input system (also used hereinafter as touch sensitive device) provides a pair of flexible, transparent plastic sheets with the facing surfaces coated with a transparent conductive material and separated by small insulating beads. A voltage divider circuit makes it possible to detect the position, x and y, where the two sheets are forced together by the touche of an operator's finger. Combining this sensing with the image displayed creates a touch system known as resistive touch. The advantage of this technology is that it is relatively inexpensive and responds intuitively to the operators touch. It however, is susceptible to wear.

In operation, though most all of the displays and touch sensitive devices of these POS systems are similar in display properties to the displays used with traditional computer set-ups (e.g., desktops, business computing uses, etc.), the displays of these POS systems undergo more significant exposure to wear and tear, chemicals, physical impact, and moisture, in particular.

For instance, though many ATM machines have a covering to assist with limiting weather exposure to the exterior of the machine, the display is often either prominently set forth or recessed such that its location in particular is directly affected by the elements of weather. Similarly, at fast food locations, many of the display devices are often only merely shielded from the elements and must be available for easy access by the customer from their vehicle. Additionally, as most of the displays of these devices require a user to input information in response to a question or command from the computer, the display devices receive varied forces and chemical exposures from the variety of users as well as the location of the devices. In most environments, and in food service environments in particular, computers are subject to liquids, foods, grease, moisture, and other contaminants. This is particularly a problem in food services where cashiers are often required to consummate transactions as well as provide the customer with the purchased food and drink.

The point of sale devices that the cashier uses to input transaction information are often subject to liquids, foods, grease, moisture from handling of the food and drink by the cashier and other contaminants incident to food service. These contaminants can be transferred to the point of sale device when the cashier inputs transaction related information (e.g., customer's order, amount tendered, etc.). Furthermore, food and drink are often spilled or drip on to the device itself. Contamination of the display and/or display cover is particularly a problem in computer systems that use touch input. This is because the cashier is constantly touching the device, handling the food and drink and because the cashier's skin generates or secretes oil naturally. Thus, these touch devices need be cleaned frequently. Cleaning the front cover compounds the situation by subjecting the device to cleaning fluids, liquids and/or solutions. The cleaning fluids can cause additional reactions with the display elements. Thus, in order to operate properly in a harsh food service environment a permanent liquid tight seal is needed to protect sensitive electronic display elements.

An example of an attempted solution to deter damage to display uses a front cover assembly 20, as is depicted in FIG. 2. FIG. 2 is a sectional view of a front cover assembly 20. The front cover assembly 20 provides a top cover 21, a seal 27, a bezel 25, protective film 26 and a piece of glass 28. The top cover 21 is typically made of a polycarbonate material using injection molding techniques as is the bezel 25 and the protective film 26 is fixed to bezel 25. However, for this approach in particular, the protective sheet is not removable without completely removing bezel 25.

Other prior attempts to reduce the effects of exposure and chemicals to display devices as discussed above by using certain coverings and adhesives are known. However, many of these attempts often require one or more of the following to result: a protective sheet be adhesively affixed to a specific portion of the display area, a specially-cut and formed sheet be accurately and particularly affixed to a localized display surface; or a protective sheet be used to encapsulate the entire device.

FIG. 3 is a depiction of an existing display system 30 with a limited protective sheet. The system of FIG. 3 has an exterior surface 31 surrounding a display area 33, wherein a protective sheet 35 is adhesively affixed to a portion of the display area. The sheet is affixed on the finally assembled display and is unable to effectively prevent seepage of liquids and the elements between the display and the exterior as there is a gap between the end of the protective sheet and the edge of the interface of the device exterior with the display.

Unfortunately, in many of these attempts, the presence of the adhesive protective sheet only further complicates the design as the adhesive is often one of the elements most susceptible to chemical damage and the difficulty with properly aligning the protective sheet requires additional skills and time in the manufacturing process. Similarly, when certain of these protective sheets are deployed with capacitive touch screens, they cause the capacitive touch screen to be inoperable due to the nature of operation of a capacitive touch screen; certain of these attempts also set forth a rigid covering further limiting the ability of a user to input responses to electronic displays. Further, though some of these attempts may provide some limited covering for the display itself, others of these attempts often fail to adequately prevent chemicals and other exposures from entering the electronic device as these attempts do not incorporate protections that also serve to protect the area between the display and its external casings.

Therefore, what is needed is an assembly and device for providing a removable, flexible, sealable touch guard system for a display that permits touch-sensitive inputs to be received. The touch guard system should also be able to offer resistance to exposure of the elements to the display, be able to offer resistance to exposure of the elements to the interface between the display and its casing, and should be easily maintained and customized by the owner. Such an assembly and device should also provide the functional benefits of a traditional touch guard and permit electronic registry of interactive inputs involving touch screens.

### BRIEF SUMMARY OF THE INVENTION

The present invention has been developed in response to the present state of the art, and in particular, in response to the problems and needs in the art that have not yet been fully solved by currently available retail devices and processes.

Accordingly, it is an overall object of the present invention to provide an assembly and device that provides a removable, flexible, sealable touch guard system for a display that is capable of creating a perimeter seal, while providing a high tolerance to resist negative effects of exposure to the elements to the display and interface area between the display and casing.

It is a further object of the invention that the present invention be configured to be easily maintained and customizable by the owner, yet provide the functional benefits of a traditional touch guard while permitting electronic registry of interactive inputs involving touch screens.

The present invention overcomes many or all of the above-discussed shortcomings in the art. To achieve the foregoing objects, and in accordance with the invention as embodied and broadly described herein in the preferred aspects and embodiments, a bezel assembly for a touch sensitive device capable of receiving touch-based inputs from users of said assembly having a rigid bezel forming an exterior portion of said assembly; a protective covering; a rigid bezel support having an upper surface and a lower surface; and a bezel fastening means for forming a primary seal; wherein said bezel is comprised of a rigid material and is adapted to be removably fastened via said bezel fastening means between said upper surface of said bezel support and a touch sensitive device positioned below said lower surface of said bezel support, is provided. Preferably the touch guard system of the present invention is adaptable for a user to customize dimensionally and/or with regard to its exterior appearance.

In one embodiment of the present invention, a bezel assembly for a touch sensitive device is provided.

In another embodiment of the present invention, a point of sale device having a sealed bezel assembly, having a point of sale display having a display having an upper surface and side edge portions defining a thickness of said display; a rigid bezel forming an exterior portion of at least said display and having a bulb edge along and defining a window opening portion; a protective covering having a surface thickness of less than 0.010 inches and a surface area greater than a surface area of said display; a rigid bezel support having an upper surface and a lower surface; and an adjustable, compressive bezel fastening means for forming a primary seal; wherein, said bezel is comprised of a rigid material and is adapted to be removably fastened via said bezel fastening means between said upper surface of said bezel support and said display below said lower surface of said bezel support, and provides a primary seal between said bulb edge and said display along said window opening portion that is liquid-tight, is provided for.

In a further embodiment of the present invention, a device of the present invention for a capacitive touch screen, wherein said surface area of said protective covering further comprises an opening portion devoid of protective covering, wherein said opening area is of a predetermined dimension less than a dimension of said window opening such that when said protective covering is removably, affixed to said display, said protective covering extends beyond said bulb edge and towards a center point of said window opening for a predetermined distance, is provided.

In yet a further embodiment of the present invention, a kit form of the present invention is provided.

An assembly and device as described above allows for a number of advantageous results, including but not limited to: reduced damage due to chemical exposure of the display and electronics of a display system as the absence of the adhesive reduces the opportunity for damage since many adhesives react poorly with chemicals; routine maintenance and customizable options by the owner; foundational benefits of a traditional touch guards while permitting electronic registry of interactive inputs involving touch screens, including capacitive resistive screens.

These and other objects, features, and advantages of the present invention will become more fully apparent from the following description and appended claims, or may be learned by the practice of the invention as set forth hereinafter. The above is merely a summary of the invention and thus contains, by necessity, simplifications, generalizations and omissions of detail; consequently, those skilled in the art will appreciate that the summary is illustrative only and is not intended to be comprehensive or limiting with regard to the invention at hand.

### BRIEF DESCRIPTION OF THE DRAWINGS

In order to better understand the manner in which the advantages, aspects and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a depiction of a common touch screen type of device, such as a point of sale terminal;

FIG. 2 is a sectional view of a front cover assembly;

FIG. 3 is a depiction of an existing display system with a limited protective sheet;

FIG. 4 is a cross-sectional view of the touch guard system for a touch sensitive device in accordance with a preferred embodiment of the present invention;

FIG. 5 is a cross-sectional overhead view of the touch guard system for a touch sensitive device in accordance with a preferred embodiment of the present invention;

FIG. 6 is a cross-sectional view of the touch guard system for a capacitive touch device in accordance with a preferred embodiment of the present invention;

FIG. 7 is a cross-sectional overhead view of the touch guard system for a capacitive touch device in accordance with a preferred embodiment of the present invention; and,

FIG. 8 is a depiction of a point of sale terminal incorporating the present invention, in accordance with a preferred embodiment.

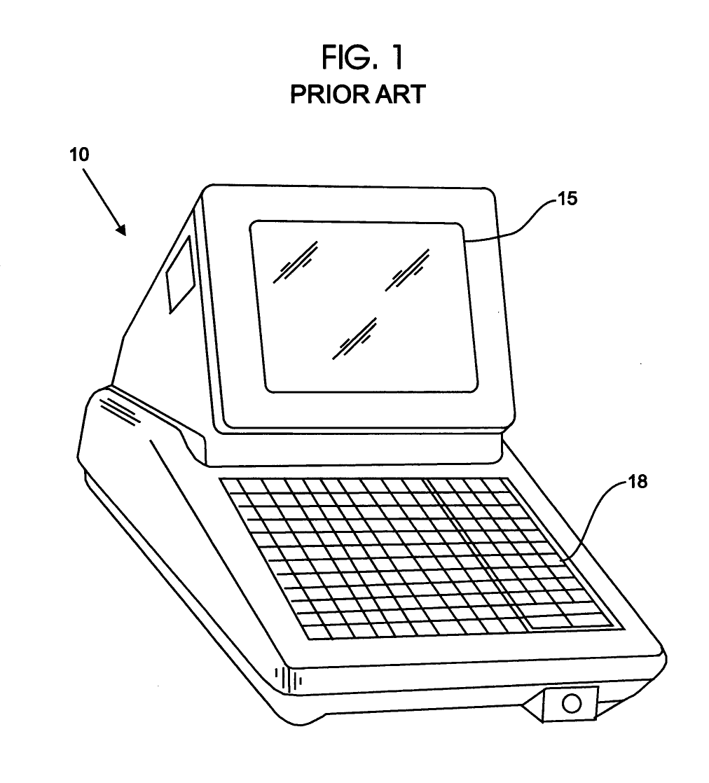

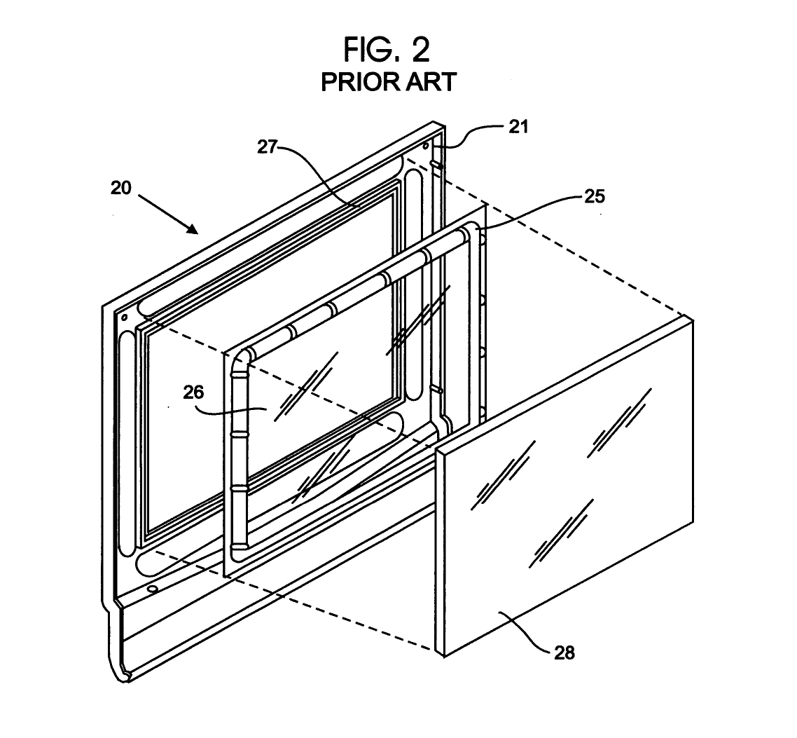

### DETAILED DESCRIPTION OF THE PREFERRED EMBODIMENTS

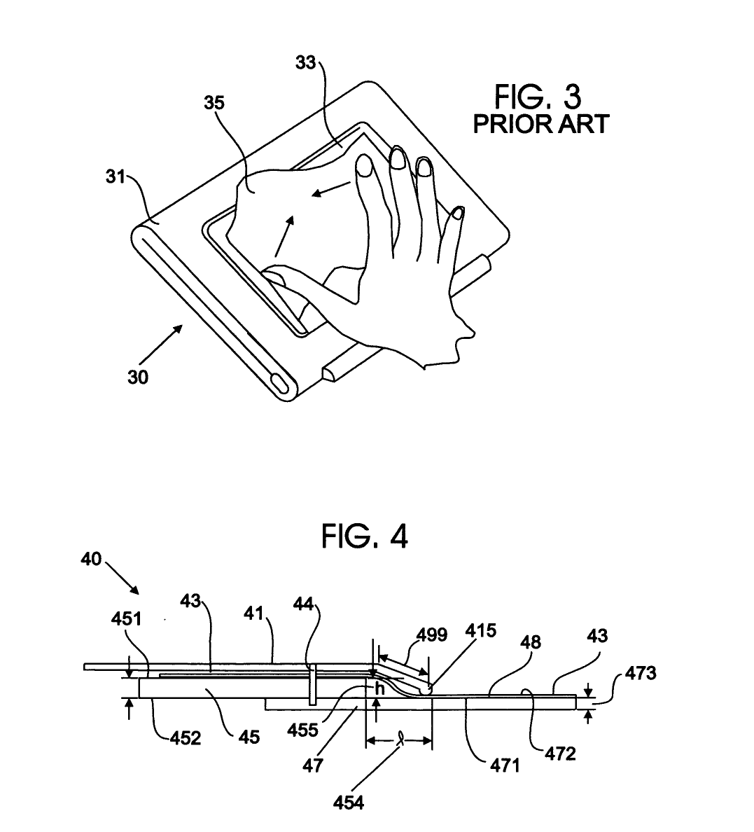

FIG. 4 is a cross-sectional view of the touch guard system for a touch sensitive device in accordance with a preferred embodiment of the present invention.

The touch guard system for the present invention, in accordance with a preferred embodiment, is a bezel assembly for a touch sensitive device. The assembly 40 is capable of receiving touch-based inputs from users using a completely assembled and operative assembly. The assembly has a rigid bezel 41 having a bulb 415 at one end which forms an exterior portion of the assembly. The exterior of the assembly is defined by the size and shape of the bezel.

A thin protective covering 43, such as a film or protective sheet, is also provided. Preferably the film is a thin plastic film having a dimensional thickness of less than 0.010 inches, the ability to flex to its original shape when a compressive force is released, and the ability to be taut without unreasonably deforming. The present invention also includes a rigid bezel support 45 that has an upper surface 451 and a lower surface 452.

A bezel fastening means 44 is provided for and the fastening means removably locks the bezel in place with the support 45 and a touch sensitive device 47 when present. The fastening means places the bulb of the bezel 415 into contact with the protective film 43 and the touch sensitive device 47, such that the contact force causes the bulb to press the protective covering to the display of the touch sensitive device, thereby deflecting the protective film into the display a predetermined distance. The contact force which creates the predetermined distance of deflection results in creating a primary seal along the contact points of deflection, which occur along the open window portion 48. As is more clearly shown in FIG. 8, the bulb edge 811 forms an open window area 812 and a contact force around the entire window area results when the assembly is assembled.

Preferably, the fastening means is a mechanical locking combination where the bezel may be mechanically locked or snapped into place with the support 45 or the touch sensitive device 47, however, such is not required for the operation of the present invention.

In a preferred embodiment, the present invention further comprises a touch sensitive device 47 having a display 471 having an upper surface 472 capable of receiving touch-based input and side edge portions 473 defining a thickness of the display 471, and the bezel is removably snapped into compression with the support and the display.

Preferably, the shape and dimension of the protective covering is determined to be at least as large as a surface area of said display plus a surface area of each side edge portion of said display, as the protective covering is to be placed over the entire display surface and over the side edges of the display. In this manner, the protective film serves to completely cover the touch sensitive device such that even if liquids or elements were to pass the primary seal formed by the fastening means, the liquids or elements would then follow gravity and further pass by the sensitive electronic components without causing harm to the components.

In a further preferred embodiment, the present invention comprises a polymer-based protective covering (e.g., film) of a predetermined shape that is symmetric about a center axis of its shape. The overall dimension of the protective covering is greater than the sum of the surface area of the display plus the surface area of each side of the edge portions of the display. In a further aspect, the surface area dimensions of the protective coating include additional amounts to account for the thickness of the support (labeled as “h” in FIG. 4 at 454, also used herein as the “vertical distance”) and the distance of the support from the bulb of the bezel (labeled as “l” in FIG. 4 at 455). These additional amounts are preferably incorporated into the overall surface area dimension of the protective coating such that the protective coating may traverse the open window portion 48, the entire display 47, at least a portion of the upper surface of the support 451 and adjacent or parallel to the angular bezel length 499. The dimensions must be slightly oversize to allow for the deflection necessary to create a seal.

In a preferred embodiment, the fastening means is secured to a predetermined force level where the predetermined compressive force is approximately equal to a minimum compressive force needed for activating the display of the touch-sensitive device. In this manner, no excessive compression force is required that may harm the display, and similarly, no inadequate force would be employed where a user using the touch sensitive device would thereby cause a gap between the bezel and the touch sensitive device if the user were to cause a deflection of the protective film and touch sensitive display that exceeded the compressive force. Similarly, additional stiffness of the protective covering has been identified due to the assembly and device comprising the sealing mechanisms of the present invention.

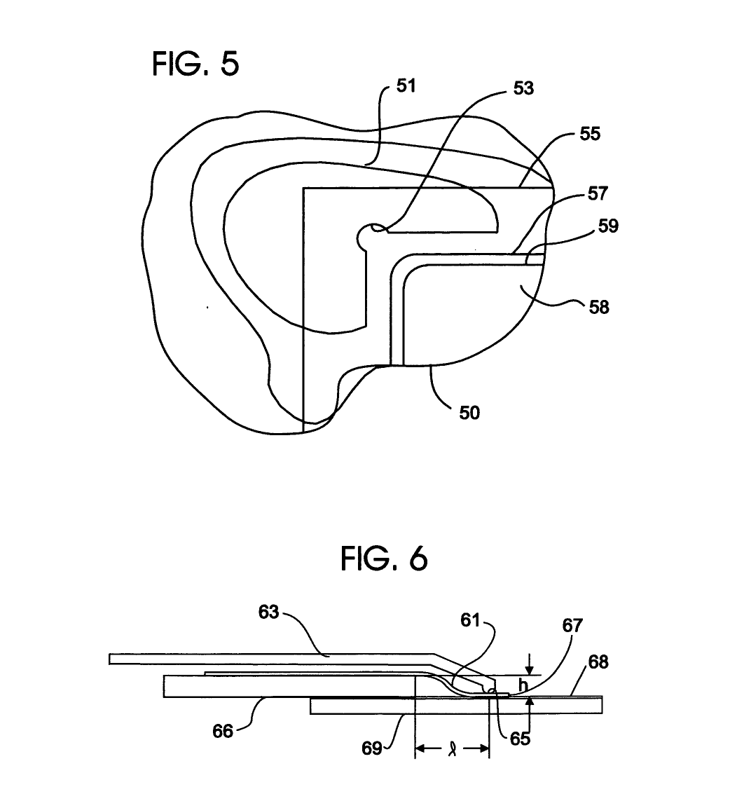

FIG. 5 is a cross-sectional overhead view of the touch guard system 50 for a touch sensitive device 55 in accordance with a preferred embodiment of the present invention. In FIG. 5, the support 51, the bezel 57, and the protective covering 58 are set forth. In a further preferred embodiment a corner relief 53, used to alleviate the likelihood of tearing or wrinkling the protective covering 58, is also provided. At a corner of an open window portion 50 (such as is also located at 48 in FIG. 4 or 812 in FIG. 8), the bulb 59 of the bezel may cause a compound deflection at a corner point given the forces along the open window edge. An additional corner relief 53 has been shown to reduce the likelihood of wrinkling of the protective covering when the protective covering is deflected by the bulb 59. Preferably, the corner relief is circular but such is not required for the proper operation of the present invention.

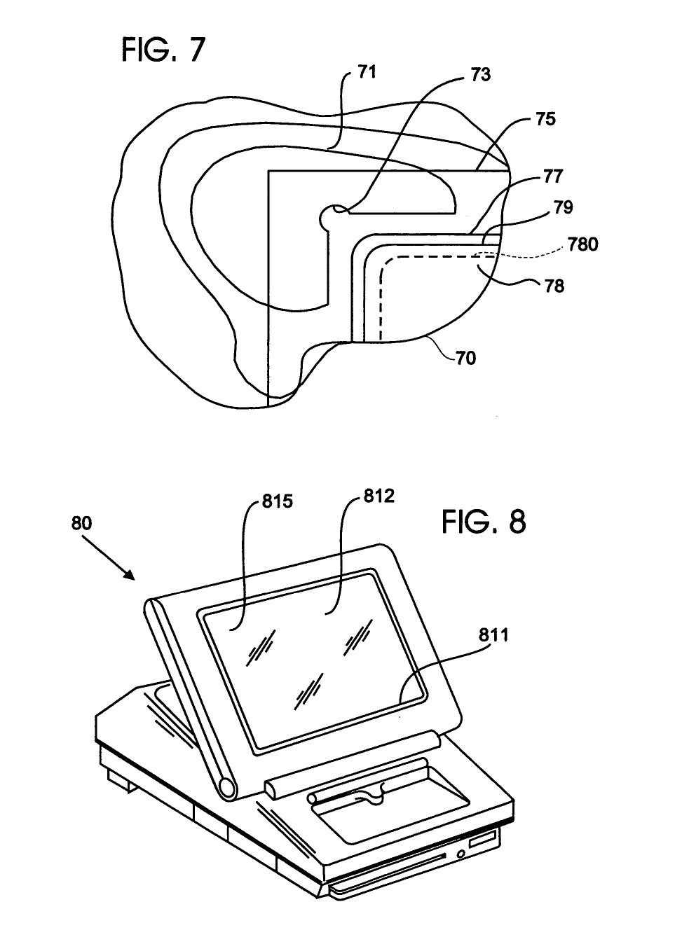

FIG. 6 is a cross-sectional view of the touch guard system 60 for a capacitive touch device 69 in accordance with a preferred embodiment of the present invention. In this preferred embodiment, the device of the present invention comprises a protective film 61, a support 66, a bezel 63, and a capacitive touch device 69 with a display 68. The preferred embodiment further comprises an ending point for the protective covering at 67 where the protective film does not traverse the entire open window surface area of the display 68. The surface area of the protective covering 61 further comprises an opening portion devoid of protective covering 67, wherein the opening area is of a predetermined dimension less than a dimension of the window opening such that when the protective covering is removably, affixed to said display 68, the protective covering extends beyond said bulb edge 65 and towards a center point of said window opening for a predetermined distance 67. FIG. 7 also further demonstrates this detail.

FIG. 7 is a cross-sectional overhead view of the touch guard system 70 for a capacitive touch device 75 in accordance with a preferred embodiment of the present invention. In FIG. 7, the support 71, the bezel 77, and the protective covering 78 are set forth. In a further preferred embodiment, the edge of the protective coating extends beyond said bulb edge 79 and towards a center point of said window opening (not shown) for a predetermined distance and ends at 78. The area extending beyond 78 towards a center point of the window opening is devoid of protective coating. Further a corner relief 73, used to alleviate the likelihood of tearing or wrinkling the protective covering is also provided. At a corner of an open window portion 70 (such as is also located at 48 in FIG. 4 or 812 in FIG. 8), the bulb 79 of the bezel may cause a compound deflection at a corner point given the forces along the open window edge (perimeter seal occurs along bulb edge 79). An additional corner relief 73 has been shown to reduce the likelihood of wrinkling of the protective covering when the protective covering is deflected the bulb 79. Preferably, the corner relief is circular but such is not required for the proper operation of the present invention.

FIG. 8 is a depiction of a point of sale terminal 80 incorporating the present invention, in accordance with a preferred embodiment. In FIG. 8, an open window portion is set forth at 812 and a bezel bulb is located along the edge at 811. The display 815 may be one of touch sensitive nature or capacitive.

Preferably the touch guard system of the present invention is adaptable for a user to customize dimensionally and/or with regard to its exterior appearance.

Advantages of the present invention include providing: (1) resistance to exposure of the elements to the display, (2) resistance to exposure of the elements to the interface between the display and its casing; (3) easily maintained and customized by the owner; (4) provides the functional benefits of a traditional touch guard and permit electronic registry of interactive inputs involving touch screens; (5) ease in cleaning and preparation for next day's use; (6) resistance to damage due to cleaning agents, liquids and the elements; (7) reduced fastening force between the bezel and touch sensor and (8) customization of unique configurations, including relatively ease in locating replacement parts.

The present invention may include customized or off the shelf technology and products without limitation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bezel assembly for a touch sensitive device capable of receiving touch-based inputs from users of said assembly, comprising:
a rigid bezel forming an exterior portion of said assembly;
a protective covering;
a rigid bezel support having an upper surface and a lower surface;
and a bezel fastening means for forming a primary seal;
wherein said bezel is comprised of a rigid material and is adapted to be removably fastened via said bezel fastening means between said upper surface of said bezel support and a touch sensitive device positioned below said lower surface of said bezel support.

2. The assembly of claim 1 further comprising a touch sensitive device having a display having an upper surface capable of receiving touch-based input and side edge portions defining a thickness of said display.

3. The assembly of claim 2 wherein said bezel fastening means forms a mechanical lock in compression between said bezel, said bezel support and said touch sensitive device.

4. The assembly of claim 3 wherein said mechanical lock provides a liquid tight seal between said bezel and said touch sensitive device.

5. The assembly of claim 4 wherein said bezel further comprises an open window portion for displaying a screen portion of said touch sensitive device.

6. The assembly of claim 5 wherein said open window portion is a cut-out portion of said bezel which provides access to said display surface of said touch sensitive device.

7. The assembly of claim 5 wherein said open window portion is comprised of a transparent plastic insert fitted to said bezel.

8. The assembly of claim 5 wherein said mechanical lock is a snap-based locking mechanism which may also be unsnapped.

9. The assembly of claim 6 wherein said protective covering is a plastic film of a predetermined dimension at least as large as a surface area of said display plus a surface area of each side edge portion of said display.

10. The assembly of claim 6 wherein said protective covering is a plastic film of a predetermined shape, wherein said area of said shape is greater than a surface area of said display plus a surface area of each side edge portion of said display.

11. The assembly of claim 10 wherein at least a portion of said lower surface of said bezel support is in contact with said upper surface of said display.

12. The assembly of claim 10 wherein said lower surface of said bezel support is located at a predetermined distance from a bulb edge of said bezel and said support has a thickness of no more than a predetermined vertical distance.

13. The assembly of claim 12 wherein said predetermined distance from said bulb edge is determined by the bulb thickness and the deflection forces on the film.

14. The assembly of claim 12 wherein said mechanical lock compresses said bulb edge of said bezel on said protective covering at a predetermined compressive force to form said primary seal between said lower surface of said bezel and said protective covering.

15. The assembly of claim 14 wherein said predetermined compressive force is approximately equal to a minimum compressive force for activating said display of said touch-sensitive device.

16. The assembly of claim 15 wherein said protective covering further comprises at least one corner relief and is of a thickness of approximately 0.007 inches.

17. A point of sale device having a sealed bezel assembly, comprising:
a point of sale display having a display having an upper surface and side edge portions defining a thickness of said display;
a rigid bezel forming an exterior portion of at least said display and having a bulb edge along and defining a window opening portion;
a protective covering having a surface thickness of at least 0.004 inches and a surface area greater than a surface area of said display;
a rigid bezel support having an upper surface and a lower surface;
and an adjustable, compressive bezel fastening means for forming a primary seal;
wherein, said bezel is comprised of a rigid material and is adapted to be removably fastened via said bezel fastening means between said upper surface of said bezel support and said display below said lower surface of said bezel support, and provides a primary seal between said bulb edge and said display along said window opening portion that is liquid-tight.

18. The device of claim 17 wherein said display is touch-sensitive.

19. The device of claim 17 wherein said display is capacitive touch sensitive.

20. The device of claim 19, wherein said surface area of said protective covering further comprises an opening portion devoid of protective covering, wherein said opening area is of a predetermined dimension less than a dimension of said window opening such that when said protective covering is removably, adhesively affixed to said display, said protective covering extends beyond said bulb edge and towards a center point of said window opening for a predetermined distance.

21. The device of claim 19 unassembled and in kit form, further comprising instructive materials for assembly of said kit.

22. The device of claim 20 unassembled and in kit form, further comprising instructive materials for assembly of said kit.
